(19) United States
(12) Patent Application Publication
(10) Pub. No.: US 2021/0072091 A1
(43) Pub. Date: Mar. 11, 2021

(54) TEMPERATURE MEASURING DEVICE

(71) Applicant: RADIANT INNOVATION INC., Hsinchu County (TW)

(72) Inventors: TSENG-LUNG LIN, Hsinchu County (TW); PO-HUNG CHEN, Taichung City (TW)

(21) Appl. No.: 16/562,443

(22) Filed: Sep. 6, 2019

(51) Int. Cl. G01K 1/08; G01K 1/24

(52) U.S. Cl. CPC G01K 1/08; G01K 7/02; G01K 1/24

(57) ABSTRACT

A temperature measuring device includes: a carrier, a temperature measuring module and a limiting member. The carrier includes a case body, a substrate disposed on the case body, a slot disposed on the case body, a first hole disposed on the case body, and a second hole. The first hole and the second hole are in communication with each other to form a gas flow path. The temperature measuring module includes a temperature measuring unit. The temperature measuring unit is disposed on the substrate, and the temperature measuring unit corresponds to the first hole. The limiting member is disposed on the carrier. The limiting member includes a positioning structure disposed on the slot and a limiting structure connected to the positioning structure.

### FIELD OF THE DISCLOSURE

The present disclosure relates to a temperature measuring device, and more particularly to a temperature measuring device that can be applied to an air conditioner outlet.

### BACKGROUND OF THE DISCLOSURE

Firstly, various thermometers for measuring temperature values are disclosed in the related art, such as a non-contact infrared thermometer or a probe thermometer. However, the related art does not disclose a temperature measuring device that is suitable for an air conditioner outlet. In general, in order to measure the temperature value of air blown from the air conditioner outlet, the probe thermometer is generally used, with the probe of the probe thermometer being placed on the air conditioner outlet.

However, in the related art, by using the probe thermometer for measuring temperature, the probe cannot be stably placed on a blade of the air conditioner outlet. Therefore, providing a temperature measuring device that can be applied to the air conditioner outlet to overcome the above defects has become one of the important issues to be solved.

### SUMMARY OF THE DISCLOSURE

In response to the above-referenced technical inadequacies, the present disclosure provides a temperature measuring device.

In one aspect, the present disclosure provides a temperature measuring device, including: a carrier, a temperature measuring module, and a limiting member. The carrier includes a case body, a substrate disposed on the case body, a slot disposed on the case body, a first hole disposed on the case body, and a second hole disposed on the case body and corresponding to the first hole. The first hole and the second hole communicate with each other to form a gas flow path. The temperature measuring module includes a temperature measuring unit disposed on the substrate, and the temperature measuring unit corresponds to the first hole. The limiting member is disposed on the carrier, and the limiting member includes a positioning structure disposed on the slot and a limiting structure connected to the positioning structure.

Therefore, one of the beneficial effects of the present disclosure is that by the technical features of “the first hole and the second hole communicating with each other to form the gas flow path” and “the limiting member being disposed on the carrier and including the positioning structure disposed on the slot and the limiting structure connected to the positioning structure,” the gas is quickly detected by the temperature measuring device by the disposition of the first hole and the second hole, and the temperature measuring device is disposed on the blade of the air conditioner outlet by the limiting structure of the limiting member.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a perspective assembled view of a temperature measuring device according to a first embodiment of the present disclosure.

FIG. 2 is a perspective assembled view of the temperature measuring device according to the first embodiment of the present disclosure.

FIG. 3 is a perspective exploded view of the temperature measuring device according to the first embodiment of the present disclosure.

FIG. 4 is a perspective exploded view of the temperature measuring device according to the first embodiment of the present disclosure.

FIG. 5 is a functional block diagram of a temperature measuring device according to an embodiment of the present disclosure.

FIG. 6 is a perspective assembled view of a case body and a limiting member of the temperature measuring device according to the first embodiment of the present disclosure.

FIG. 7 is a perspective sectional view of the case body and the limiting member of the temperature measuring device according to the first embodiment of the present disclosure.

FIG. 8 is a perspective sectional view of the first housing of the case body of the temperature measuring device according to the first embodiment of the present disclosure.

FIG. 9 is a perspective sectional view of the temperature measuring device according to the first embodiment of the present disclosure.

FIG. 10 is a schematic view of the temperature measuring device in use according to the first embodiment of the present disclosure.

FIG. 11 is a perspective assembled view of the temperature measuring device according to a second embodiment of the present disclosure.

FIG. 12 is a perspective assembled view of the temperature measuring device according to the second embodiment of the present disclosure.

FIG. 13 is a perspective assembled view of a case body and a limiting member of the temperature measuring device according to the second embodiment of the present disclosure.

FIG. 14 is a perspective sectional view of the case body and the limiting member of the temperature measuring device according to the second embodiment of the present disclosure.

FIG. 15 is a schematic view of the temperature measuring device in use according to the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

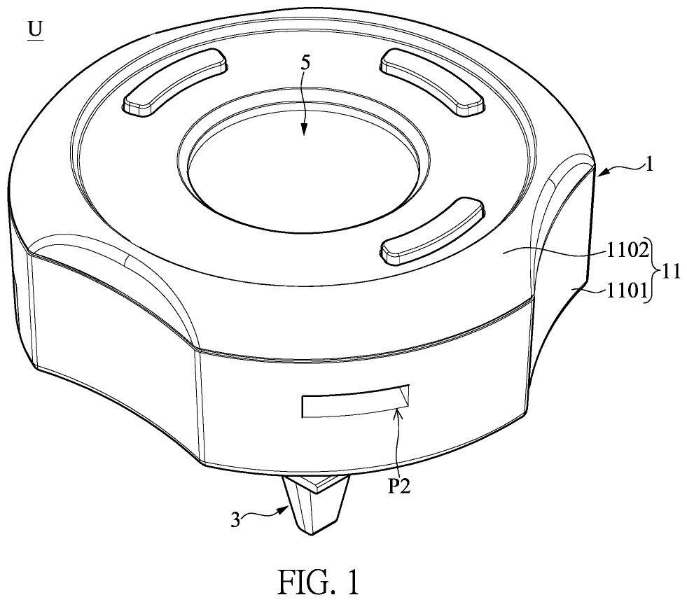

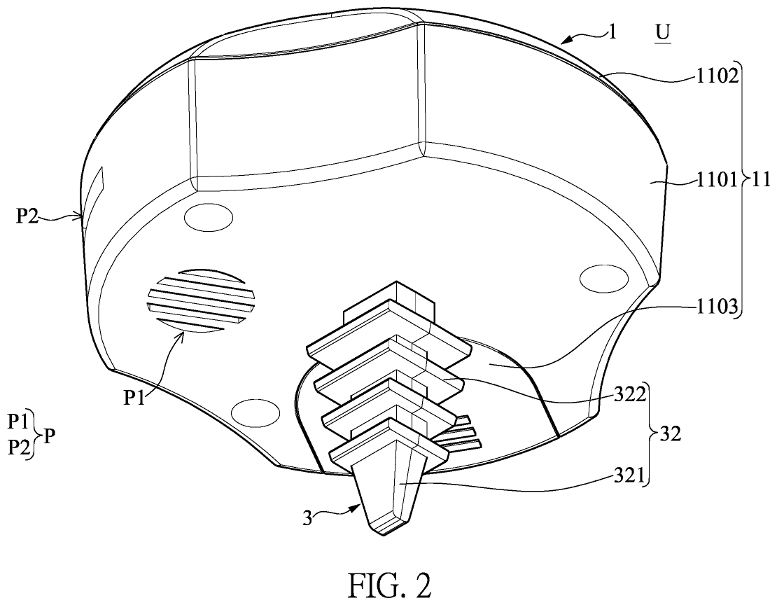

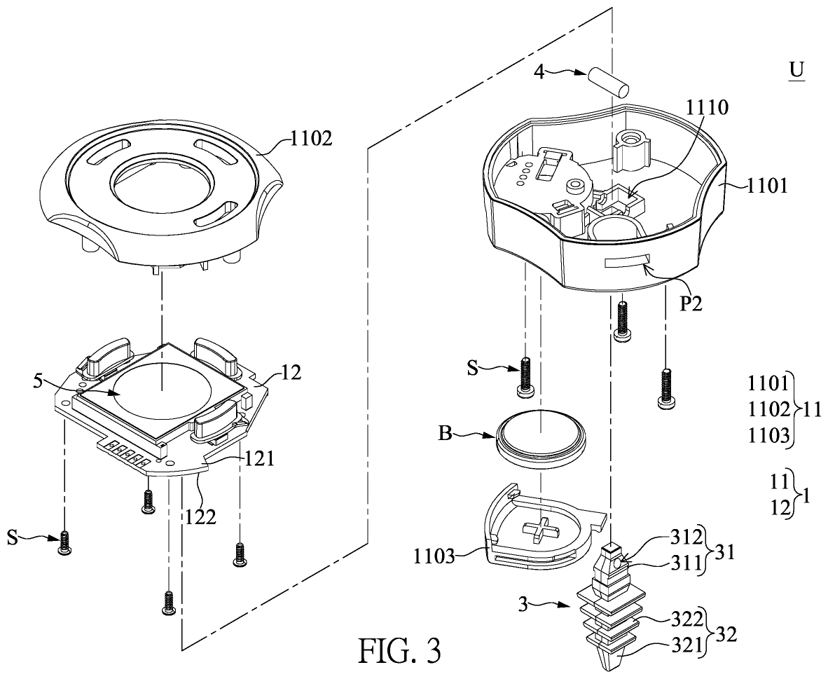

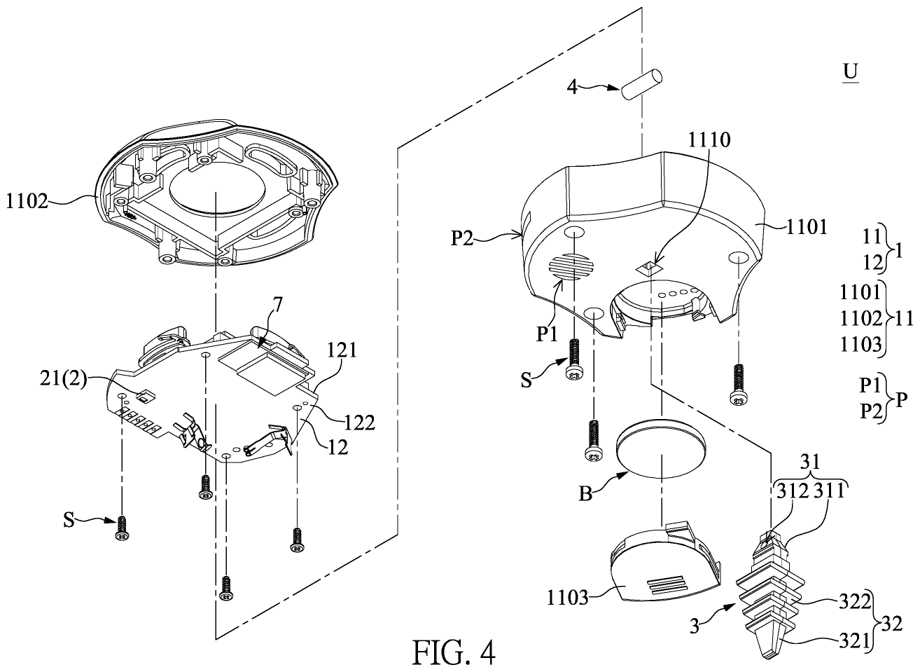

Referring to FIG. 1 to FIG. 4, FIG. 1 and FIG. 2 are perspective assembled views of a temperature measuring device according to a first embodiment of the present disclosure, and FIG. 3 and FIG. 4 are perspective exploded views of the temperature measuring device according to the first embodiment of the present disclosure. The present disclosure provides a temperature measuring device U preferably applied to an air conditioner outlet of a car for measuring the temperature of the cold air from an air conditioner of an automobile. The temperature measuring device U may include: a carrier 1, a temperature measuring module 2 and a limiting member 3. The temperature measuring module 2 can be disposed on the carrier 1 and the limiting member 3 can be disposed on the carrier 1 so that the temperature measuring device U can be disposed on the air conditioner outlet of the automobile by using the limiting member 3.

As mentioned above, the carrier 1 may include a case body 11, a substrate 12 disposed on the case body 11, a slot 1110 disposed on the case body 11, a first hole P1 disposed on the case body 11, and a second hole P2 disposed on the case body 11 and corresponding to the first hole P1. The first hole P1 and the second hole P2 may penetrate the case body 11, and the first hole P1 and the second hole P2 communicate with each other to form a gas flow path P.

For example, the case body 11 of the carrier 1 may include a first housing 1101 and a second housing 1102 corresponding to the first housing 1101, and the substrate 12 may be disposed between the first housing 1101 and the second housing 1102. In addition, for example, the first housing 1101 and the second housing 1102 can be combined by a locking member S, and the substrate 12 can also be disposed on the second housing 1102 through the locking member S. In addition, for example, the slot 1110 may be disposed on the first housing 1101, and the first hole P1 and the second hole P2 may also be disposed on the first housing 1101. In addition, for example, the case body 11 may further include a cover 1103 disposed on the first housing 1101, and the cover 1103 and the first housing 1101 may have an accommodation space (not labeled) for disposing the battery B therein. However, the above-mentioned examples are only one of the embodiments and the present disclosure is not limited thereto.

As mentioned above, the temperature measuring module 2 may include a temperature measuring unit 21, the temperature measuring unit 21 may be disposed on the substrate 12, and the temperature measuring unit 21 may correspond to the first hole P1. The limiting member 3 can be disposed on the first housing 1101 of the carrier 1. Further, the limiting member 3 may include a positioning structure 31 disposed on the slot 1110 and a limiting structure 32 connected to the positioning structure 31.

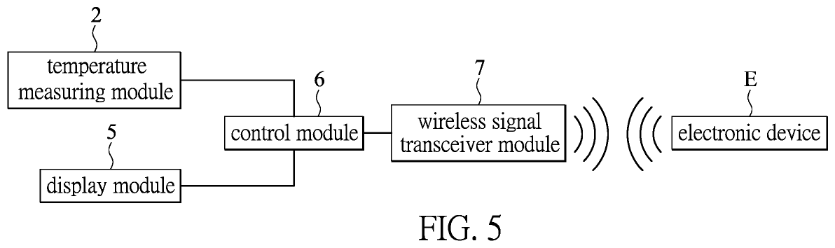

Then, as shown in FIG. 1 to FIG. 4 and FIG. 5, FIG. 5 is a functional block diagram of a temperature measuring device according to an embodiment of the present disclosure. The temperature measuring device U can further include a display module 5, and the display module 5 can be coupled to the temperature measuring module 2 to display the temperature value measured by the temperature measuring module 2. In addition, the temperature measuring device U may further include a control module 6 and a wireless signal transceiver module 7. The temperature measuring module 2 can be coupled to the control module 6. The display module 5 can be coupled to the control module 6 and indirectly coupled to the temperature measuring module 2, and the wireless signal transceiver module 7 can be coupled to the control module 6. Therefore, the wireless signal transceiver module 7 can transmit the temperature value measured by the temperature measuring module 2 to an electronic device E (such as but not limited to a smart phone). In addition, the control module 6 can include a control button (not labeled in the figure) to control the temperature measuring device U. In addition, in an embodiment, the electronic device E can also control the temperature measuring device U through the wireless signal transceiver module 7. In addition, it should be noted that the coupling in the present disclosure may be a direct electrical connection or an indirect electrical connection, and the present disclosure is not limited thereto.

As mentioned above, for example, the substrate 12 may include a first surface 121 and a second surface 122 corresponding to the first surface 121. The display module 5 may be disposed on the first surface 121 of the substrate 12, and the temperature measuring unit 21 may be disposed on the second surface 122 of the substrate 12. Therefore, a direction in which the display module 5 faces and a direction in which the temperature measuring unit 21 faces are opposite to each other. In addition, the control module 6 and the wireless signal transceiver module 7 can also be disposed on the substrate 12.

As mentioned above, for example, the substrate 12 can be a printed circuit board (PCB). The control module 6 can be a microcontroller (MCU) for processing or computing information. The display module 5 can be a display, such as, but not limited to, a liquid crystal display (LCD) for displaying information such as temperature. The wireless signal transceiver module 7 may be a radio frequency device, such as Bluetooth, to transmit information such as temperature values to the electronic device E. The temperature measuring module 2 can be a resistance thermometer or a thermocouple thermometer. However, the above-mentioned examples illustrate only one of the embodiments, and the present disclosure is not limited thereto.

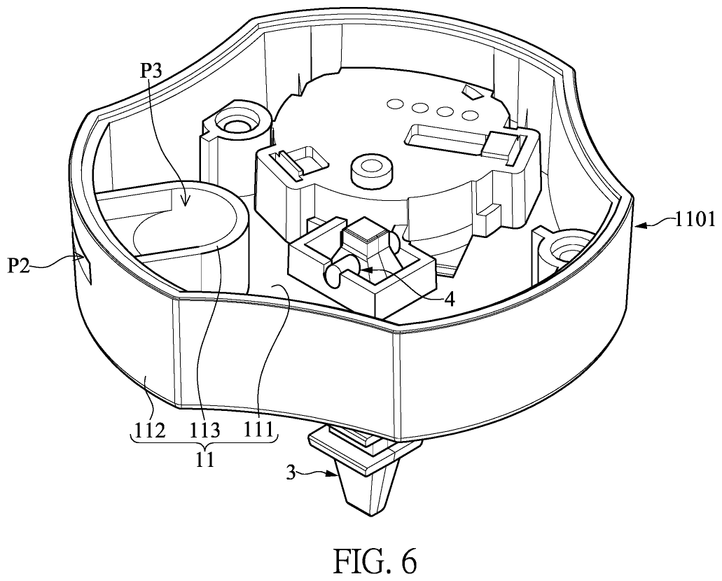

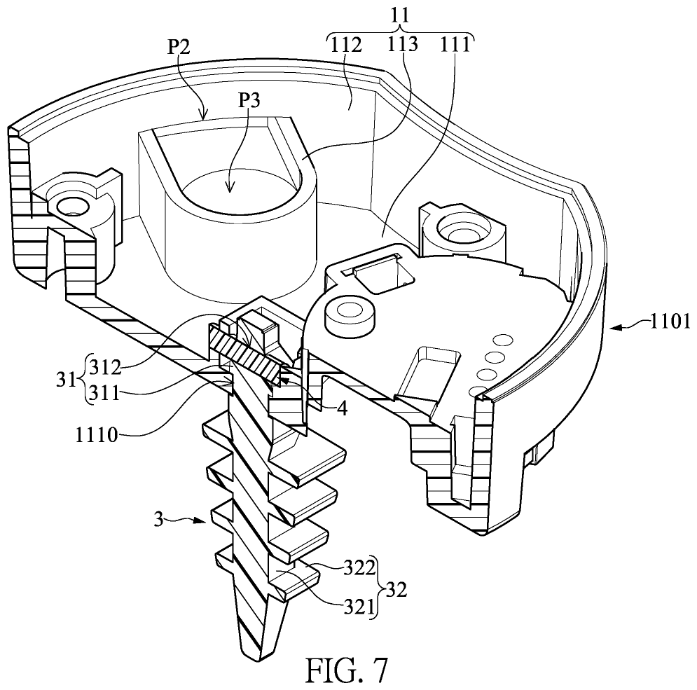

Referring to FIG. 6 and FIG. 7, FIG. 6 is a perspective sectional view of a case body and a limiting member of the temperature measuring device according to the first embodiment of the present disclosure, and FIG. 7 is a perspective sectional view of the case body and the limiting member of the temperature measuring device according to the first embodiment of the present disclosure. In the first embodiment, the limiting structure 32 of the limiting member 3 may include a cylinder 321 and a plurality of limiting pads 322 disposed on the cylinder 321, and the plurality of limiting pads 322 may be sequentially arranged in a direction away from the positioning structure 31. In addition, the positioning structure 31 of the limiting member 3 may include a locking member 311 corresponding to the slot 1110 of the case body 11. Therefore, the locking member 311 of the limiting member 3 can be buckled in the slot 1110, and the limiting member 3 is disposed on the case body 11.

As mentioned above, the temperature measuring device U may further include a positioning member 4, and the positioning structure 31 of the limiting member 3 may further include a positioning hole 312. The positioning member 4 may be columnar, and the positioning member 4 may be inserted in the positioning hole 312 and abutted against the case body 11. Therefore, a position of the limiting member 3 with respect to the case body 11 can be further fixed.

Next, referring to FIG. 6 and FIG. 7, a plurality of limiting pads 322 may be sequentially arranged in the direction away from the positioning structure 31. One of two adjacent limiting pads 322 that is farther from the positioning structure 31 is smaller than the other one of the two adjacent limiting pads 322 that is closer to the positioning structure 31. In other words, the plurality of limiting pads 322 may be tapered in a direction away from the positioning structure 31. In other words, the limiting member 3 of the first embodiment may have a vertebral structure. In addition, each limiting pad 322 can be in the form of a sheet, and each of the limiting pads 322 can be surroundingly disposed on the cylinder 321. In addition, it should be noted that the material of the limiting pad 322 may have flexibility, such as, but not limited to, a material such as rubber.

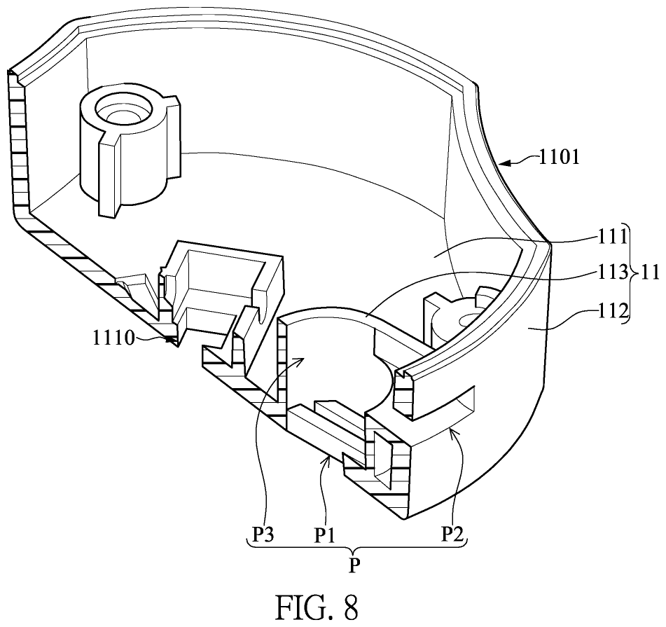

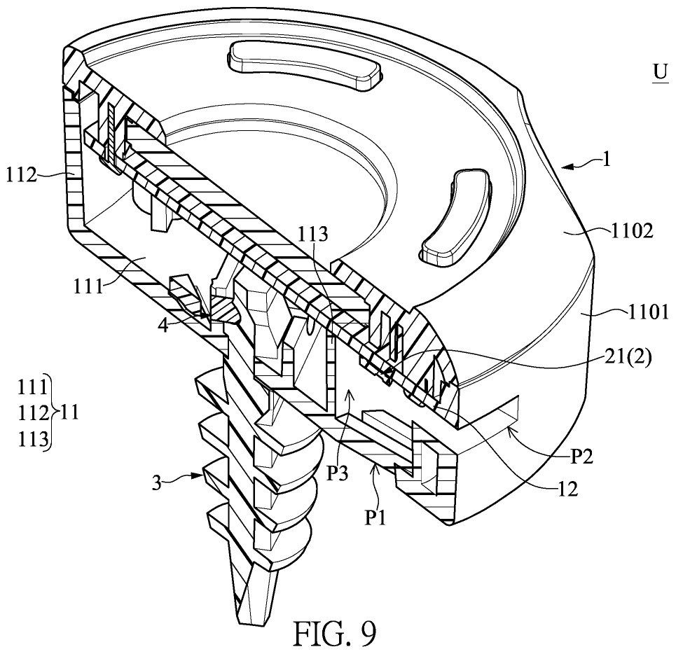

Next, referring to FIG. 8 and FIG. 9, FIG. 8 is a perspective sectional view of the first housing of the case body of the temperature measuring device according to the first embodiment of the present disclosure, and FIG. 9 is a perspective sectional view of the temperature measuring device according to the first embodiment of the present disclosure. For example, the case body 11 may include a base plate 111 and a surrounding side plate 112 connected to the base plate 111, and the surrounding side plate 112 may be vertically disposed with respect to the base plate 111. In addition, the first hole P1 may be disposed on the base plate 111, the second hole P2 may be disposed on the surrounding side plate 112, and the slot 1110 may be disposed on the base plate 111. Further, in the first embodiment of the present disclosure, the case body 11 may further include a first airflow guide 113 disposed on the base plate 111 and connected to the surrounding side plate 112, and at least one first hole P1 may be disposed between the first airflow guide 113 and the surrounding side plate 112. In addition, a first path P3 can be formed between the first airflow guide 113, the substrate 12 and the surrounding side plate 112, and the first hole P1 and the second hole P2 can communicate with each other through the first path P3, so that the first hole P1, the first path P3 and the second hole P2 jointly form a gas flow path P. Therefore, air blown from the air conditioner outlet can sequentially pass the first hole P1, the first path P3 and the second hole P2 to accelerate an efficiency of the temperature measurement.

As mentioned above, furthermore, a vertical projection of the temperature measuring unit 21 relative to the substrate 12 can form a first projection area (not released in the figure), a vertical projection of the first hole P1 relative to the substrate 12 can form a second projection area (not released in the figure), and at least part of the first projection area and part of the second projection area overlap with each other. In other words, when the temperature measuring device U provided by the first embodiment of the present disclosure is disposed on the air conditioner outlet, the air blown from the air conditioner outlet can be directly blown onto the temperature measuring unit 21 through the first hole P1, so that the temperature measuring unit 21 can directly measure the temperature value of the airflow.

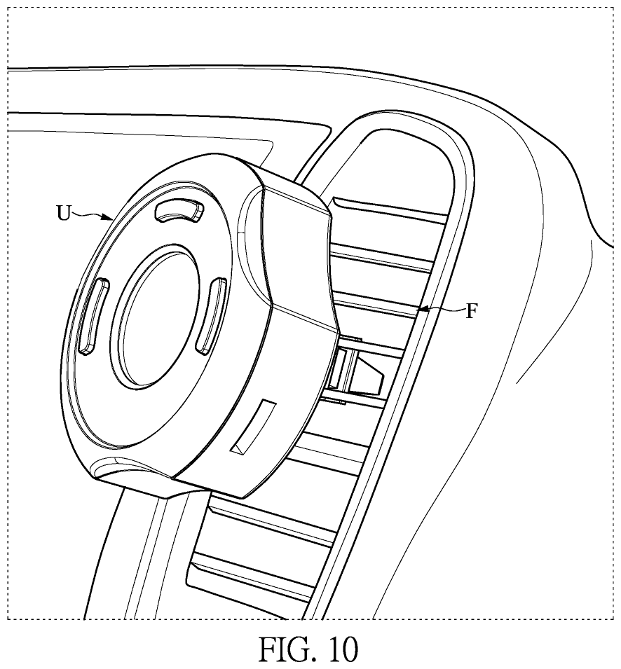

Next, referring to FIG. 10, FIG. 10 is a schematic view of the temperature measuring device in use according to the first embodiment of the present disclosure. When the temperature measuring device U provided by the first embodiment of the present disclosure is disposed on the air conditioner outlet, the flexible limiting pad 322 can be disposed between two adjacent ones of blades F of the air conditioner outlet, so that the temperature measuring device U provided by the present disclosure is disposed on the air conditioner outlet. In addition, it should be noted that since the size of the plurality of limiting pads 322 can be tapered along the direction away from the positioning structure 31, the temperature measuring device U provided by the embodiment of the present disclosure can be applied to air conditioner outlets of different sizes.

### Second Embodiment

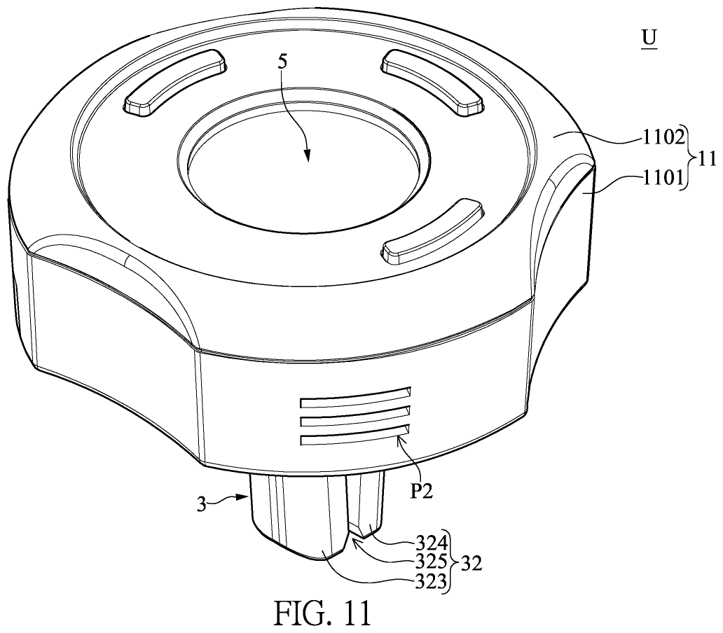

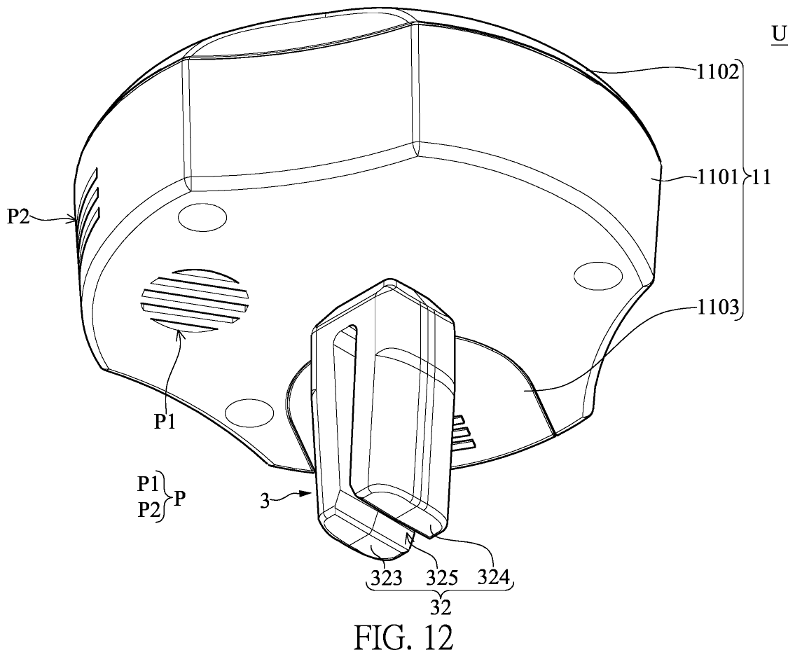

Referring to FIG. 11 and FIG. 12, FIG. 11 and FIG. 12 are perspective assembled views of a temperature measuring device according to a second embodiment of the present disclosure. The second embodiment of the present disclosure provides a temperature measuring device U that is slightly similar to the temperature measuring device U of the first embodiment. Therefore, similar steps will not be repeated herein. Further, according to FIG. 11 and FIG. 12 and FIG. 1 and FIG. 2, the difference between the second embodiment of the present disclosure and the first embodiment is that, the configuration of the limiting member 3 of the temperature measuring device U of the second embodiment of the present disclosure may be different, and the arrangement of the second hole P2 may also be changed.

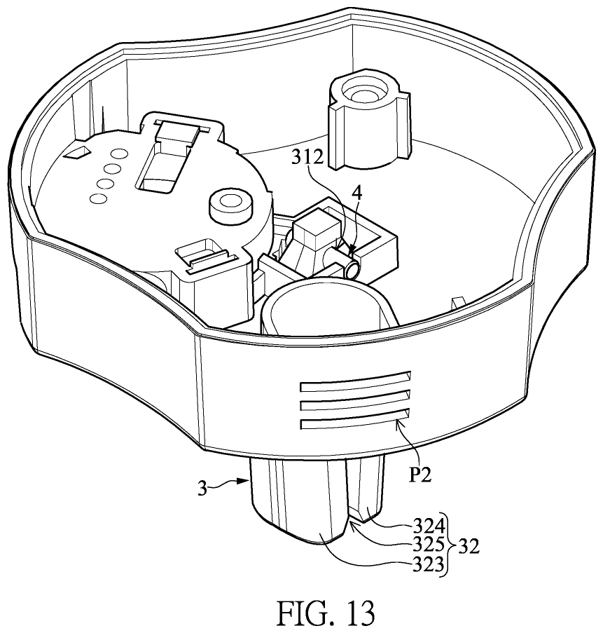

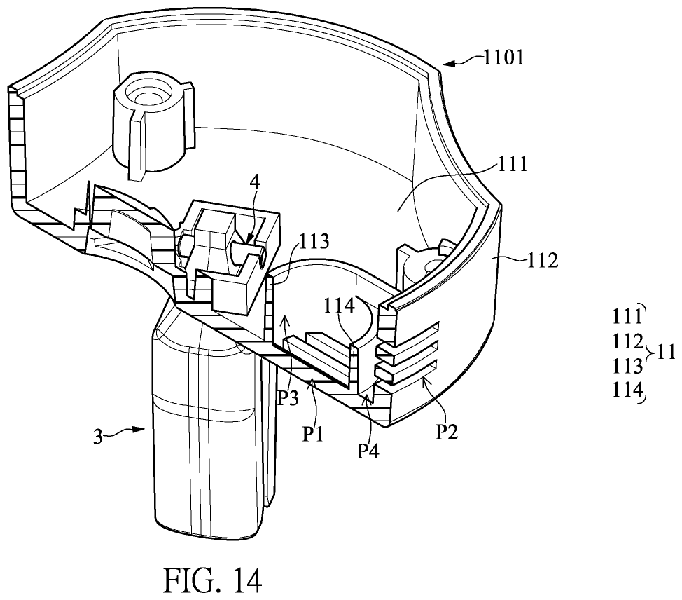

Next, referring to FIG. 11 and FIG. 12, and referring to FIG. 13 and FIG. 14, FIG. 13 is a perspective assembled view of a case body and a limiting member of the temperature measuring device according to the second embodiment of the present disclosure, and FIG. 14 is a perspective sectional view of the case body and the limiting member of the temperature measuring device according to the second embodiment of the present disclosure. In the second embodiment of the present disclosure, the limiting structure 32 of the limiting member 3 may include a first clip 323 connected to the positioning structure 31 and a second clip 324 connected to the positioning structure 31 corresponding to the first clip 323, and a limiting slot 325 is formed between the first clip 323 and the second clip 324. In other words, the first clip 323, the second clip 324, and the limiting slot 325 can form a U-shaped structure. In addition, the positioning structure 31 of the limiting member 3 may include a locking member 311 corresponding to the slot 1110 of the case body 11, so that the locking member 311 of the limiting member 3 may be buckled in the slot 1110, and the limiting member 3 is disposed on the case body 11. In addition, it should be noted that, the material of the limiting pad 322 may have flexibility, such as, but not limited to, a material such as rubber.

As mentioned above, the temperature measuring device U may further include a positioning member 4, and the positioning structure 31 of the limiting member 3 may further include a positioning hole 312. The positioning member 4 may be columnar, and the positioning member 4 may be inserted in the positioning hole 312, and the positioning member 4 may abut against the case body 11. Therefore, a position of the limiting member 3 with respect to the case body 11 can be further fixed. In other words, the positioning structure 31 of the limiting member 3 of the temperature measuring device U of the second embodiment is similar to that of the positioning structure 31 of the limiting member 3 of the temperature measuring device U of the first embodiment, and will not be described herein.

In continuance of the above, the case body 11 may include a base plate 111 and a surrounding side plate 112 connected to the base plate 111, at least one first hole P1 is disposed on the base plate 111, at least one second hole P2 is disposed on the surrounding side plate 112, and the surrounding side plate 112 is vertically disposed with respect to the base plate 111. In addition, referring to FIG. 9, the substrate 12 of the temperature measuring device U of the second embodiment is similar to the position of the substrate 12 of the temperature measuring device U of the first embodiment. Therefore, in the second embodiment, a vertical projection of the temperature measuring unit 21 relative to the substrate 12 can form a first projection area, a vertical projection of the first hole P1 relative to the substrate 12 can form a second projection area, and at least part of the first projection area and part of the second projection area overlap with each other.

Next, referring to FIG. 9, FIG. 13, and FIG. 14, in the second embodiment of the present disclosure, the case body 11 may further include a first airflow guide 113 disposed on the base plate 111 and connected to the surrounding side plate 112, and a second airflow guide 114 disposed on the base plate 111 and connected to the first airflow guide 113. The second airflow guide 114 may be disposed between the first airflow guide 113 and the surrounding side plate 112, the first hole P1 may be disposed between the first airflow guide 113 and the surrounding side plate 112, and the first hole P1 is disposed between the first airflow guide 113 and the second airflow guide 114. In other words, the first airflow guide 113 and the second airflow guide 114 are surroundingly disposed on the first hole P1.

As mentioned above, a first path P3 can be formed between the first airflow guide 113, the second airflow guide 114 and the substrate 12, and a second path P4 can be formed between the second airflow guide 114, the substrate 12 and the surrounding side plate 112, and the first hole P1 and the second hole P2 can communicate with each other through the first path P3 and the second path P4, so that the first hole P1, the first path P3, the second path P4, and the second hole P2 form a gas flow path P. In addition, it should be noted that the first airflow guide 113 may be disposed on the base plate 111 and extend toward the substrate 12, and the second airflow guide 114 may be disposed on the base plate 111 and extend toward the substrate 12, a distance between the extended end of the first airflow guide 113 (not labeled) and the substrate 12 is less than a distance between the extended end of the second airflow guide 114 (not labeled) and the substrate 12. Therefore, air blown from the air conditioner outlet can be guided by the first airflow guide 113, so that most of the airflow can flow directly to the second hole P2.

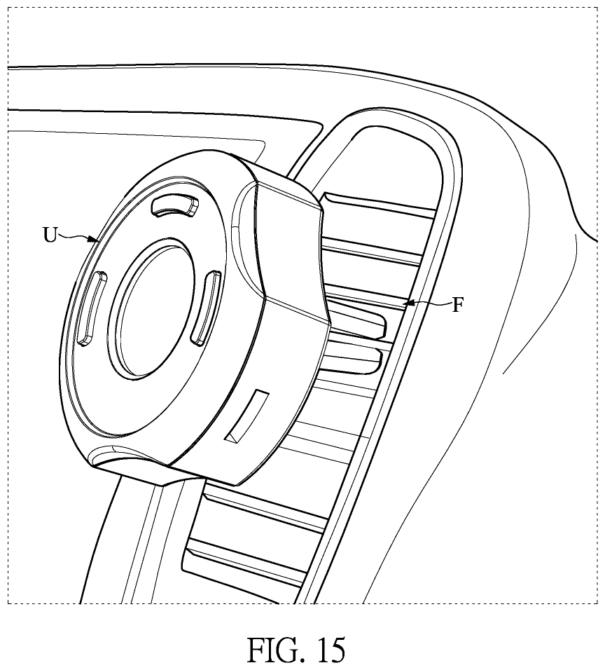

Next, referring to FIG. 15, FIG. 15 is a schematic view of the temperature measuring device in use according to the second embodiment of the present disclosure. When the temperature measuring device U provided by the second embodiment of the present disclosure is disposed on the air conditioner outlet, the limiting structure 32 of the limiting member 3 can be disposed on the blades F of the air conditioner outlet. That is to say, the limiting structure 32 can be inserted on the blades F, so that the blades F are located in the limiting slot 325 of the limiting structure 32, and the temperature measuring device U abuts against the blades F by the first measuring device and the second clip 324.

In conclusion, one of the beneficial effects of the present disclosure is that by the technical features of “the first hole P1 and the second hole P2 communicating with each other to form the gas flow path P” and “the limiting member 3 including the positioning structure 31 disposed on the slot 1110 and the limiting structure 32 connected to the positioning structure 31 disposed on the carrier 1,” the gas can be quickly detected by the temperature measuring device by the configuration of the first hole P1 and the second hole P2, and the configuration of the temperature measuring device U being disposed on the blade F of the air conditioner outlet through the limiting structure 32 of the limiting member 3.

Furthermore, the temperature measuring device U provided by the present disclosure can be applied when an automobile air-conditioner needs to be repaired, that is, the temperature value measured by the temperature measuring device U can be transmitted to the electronic device E by the configuration of the wireless signal transceiver module 7, so that maintenance personnel can be informed of the current temperature value of the air conditioner by using the electronic device E, instead of viewing the current temperature value of the air conditioner by observing the display module 5 disposed on the temperature measuring device U.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A temperature measuring device, comprising:
a carrier including a case body, a substrate disposed on the case body, a slot disposed on the case body, a first hole disposed on the case body, and a second hole disposed on the case body and corresponding to the first hole, wherein the first hole and the second hole communicate with each other to form a gas flow path;
a temperature measuring module including a temperature measuring unit that is disposed on the substrate and that corresponds to the first hole; and
a limiting member disposed on the carrier and including a positioning structure disposed on the slot and a limiting structure connected to the positioning structure.

2. The temperature measuring device according to claim 1, further comprising: a display module; wherein the substrate includes a first surface and a second surface, the display module is disposed on the first surface of the substrate, and the temperature measuring unit is disposed on the second surface of the substrate.

3. The temperature measuring device according to claim 1, further comprising: a wireless signal transceiver module disposed on the substrate.

4. The temperature measuring device according to claim 1, wherein the limiting structure of the limiting member includes a cylinder and a plurality of limiting pads disposed on the cylinder, and the plurality of limiting pads are sequentially arranged in a direction away from the positioning structure.

5. The temperature measuring device according to claim 1, wherein the plurality of limiting pads are sequentially arranged in a direction away from the positioning structure, and one of the two adjacent limiting pads that is farther from the positioning structure is smaller than the other one of the limiting pads that is closer to the positioning structure.

6. The temperature measuring device according to claim 4, wherein each of the limiting pads is in a sheet shape, and each of the limiting pads is surroundingly disposed on the cylinder.

7. The temperature measuring device according to claim 1, wherein the limiting structure includes a first clip connected to the positioning structure and a second clip connected to the positioning structure and corresponding to the first clip, and a limiting slot is formed between the first clip and the second clip.

8. The temperature measuring device according to claim 1, wherein the case body includes a base plate and a surrounding side plate connected to the base plate, the first hole is disposed on the base plate, the second hole is disposed on the surrounding side plate, and the surrounding side plate is vertically disposed with respect to the base plate.

9. The temperature measuring device according to claim 8, wherein the case body further includes a first airflow guide disposed on the base plate and connected to the surrounding side plate, and the first hole is disposed between the first airflow guide and the surrounding side plate; wherein a first path can be formed between the first airflow guide, the substrate, and the surrounding side plate, and the first hole and the second hole can communicate with each other through the first path so that the first hole, the first path, and the second hole form the gas flow path.

10. The temperature measuring device according to claim 8, wherein the case body further includes a first airflow guide disposed on the base plate and connected to the surrounding side plate, and a second airflow guide disposed on the base plate and connected to the first airflow guide, the second airflow guide being disposed between the first airflow guide and the surrounding side plate, the first hole being disposed between the first airflow guide and the surrounding side plate, and the first hole being disposed between the first airflow guide and the second airflow guide; wherein a first path can be formed between the first airflow guide, the second airflow guide, and the substrate, a second path can be formed between the second airflow guide, the substrate, and the surrounding side plate, and the first hole and the second hole can communicate with each other through the first path so that the first hole, the first path, the second path and the second hole form the gas flow path.

11. The temperature measuring device according to claim 1, wherein a vertical projection of the temperature measuring unit relative to the substrate can form a first projection area, a vertical projection of the first hole relative to the substrate can form a second projection area, and at least part of the first projection area and part of the second projection area overlap with each other.
